(19) United States
(12) Patent Application Publication
(10) Pub. No.: US 2012/0251339 A1
(43) Pub. Date: Oct. 4, 2012

(54) METHOD AND APPARATUS FOR OSCILLATING A FOIL IN A FLUID

(76) Inventor: Bas Goris, Rotterdam (NL)

(21) Appl. No.: 13/392,053

(22) PCT Filed: Aug. 24, 2010
(86) PCT No.: PCT/NL10/00125

§ 371 Date: May 14, 2012

(30) Foreign Application Priority Data
Aug. 24, 2009 (NL) 2003387

(51) Int. Cl. F03C 4/00; F04B 19/20

(52) U.S. Cl. 417/53; 417/279; 416/79

(57) ABSTRACT

The present invention relates to a method and apparatus for oscillating a foil in a fluid. The method according to the invention comprises the steps of —generating an oscillating heave motion of the foil in the fluid, the oscillation cycle of the heave motion consisting of two strokes of the foil in opposite direction; —generating an oscillating pitching motion of the foil in the fluid; characterized by —controlling the heave motion; and —adjusting the pitch during the oscillation cycle of the heave motion; such that —over 65% to 85% of the oscillation cycle of the heave motion, for each stroke of the foil, the absolute angle of attack is more than 60% of the maximum absolute angle of attack during the stroke.

The present invention relates to a method and apparatus for oscillating a foil in a fluid.

Oscillating or flapping foils were inspired by the nature of marine swimmers such as the tuna fish, shark, dolphin and whale. Marine swimmers use the combined effects of lift by vortices and lift by attached flow over a curved wing. Current industrial oscillating foils works with the principle of an attached flow over a curved wing. The lift is generated when the foil has an angle with the incoming flow of a medium. The lift is defined as the component of force acting in the plane of symmetry in the direction perpendicular to the incoming medium.

The method according to the invention comprises the steps of

generating an oscillating heave motion of the foil in the fluid, the oscillation cycle of the heave motion consisting of two strokes of the foil in opposite direction;

generating an oscillating pitching motion of the foil in the fluid;

characterized by

controlling the heave motion; and

adjusting the pitch during the oscillation cycle of the heave motion;

such that

over 65% till 85% of the oscillation cycle of the heave motion, for instance 65%, 66%, 67%, 68%, 69%, 70%, 71%, 72%, 73, 74%, 75%, 76%, 77%, 78%, 79%, 80%, 81%, 82%, 83%, 84%, 85%, for each stroke of the foil, the absolute angle of attack is more than 60% of the maximum absolute angle of attack during the stroke, for instance 61%, 62%, 63%, 64%, 65%, 66%, 67%, 68%, 69%, 70%, 71%, 72%, 73, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%.

With an oscillating foil, both pitch and heave motions of the foil member need to be controlled, periodically and precisely, to produce the maximum possible efficiency and thrust.

The known methods for oscillating a foil in a fluid, and the design of currently known apparatuses for oscillating a foil in a fluid derived from these know methods, are aimed at generating a pure sinus shaped motion of both pitch and heave resulting in a sinus shape motion of the Angle of Attack as known from theoretical models. An angle of attack, plotted in a graph against the time of one cycle, equal to a sinus has values of more than 60% of the maximum angle of attack (per stroke of the foil) over 59.4% of the cycle, where a cycle is the up and the down stroke of the foil.

Angle of attack is a term used in fluid dynamics to describe the angle between a reference line on a body (in this case the chord line of a foil) and the vector representing the relative motion between the body and the fluid through which it is moving. In general, the reference line could be any line on any arbitrarily shaped body in a flow. The angle of attack would be the angle between the line and the oncoming flow. For a two-dimensional representation of a foil, the angle of attack is the angle between the chord line of the foil and the direction of arrival of the incoming fluid. For the two dimensional representation of the direction of arrival of the incoming fluid the average motion of the fluid over the span of the foil can be taken. Since a foil can have twist, a chord line of the whole foil may not be definable. In that case an alternate reference line is defined. Often, the chord line of the root of the foil is chosen as the reference line.

When applying the method according to the invention relative to the application of the known methods that are aimed at generating a sinus shape motion of the angle of attack, a flattened curve is found for at least one of the strokes when the absolute angle of attack as a percentage of the maximum absolute angle of attack is plotted against the time. This has the advantage over the known methods of a particularly high mean thrust and a high mean efficiency of each oscillation cycle of the heave motion.

In an advantageous embodiment of the method according to the invention 65% to 85% of the oscillation cycle of the heave motion is 65% to 85% of the time to complete one cycle of the heave motion. In an alternative embodiment the 65% to 85% of the oscillation cycle of the heave motion is 65% to 85% of the path of the foil during one cycle of the heave motion.

In an advantageous embodiment of the method according to the invention for each stroke of the foil, the absolute angle of attack is more than 60% of the maximum absolute angle of attack during the stroke over 65% to 85% of the stroke. This embodiment makes it possible to have a particularly high mean thrust and a high mean efficiency for each stroke of the heave motion. Preferably, the absolute angle of attack is more than 60% of the maximum absolute angle of attack during the stroke over 65% to 85% of the time to complete the stroke. Alternatively, the absolute angle of attack is more than 60% of the maximum absolute angle of attack during the stroke over 65% to 85% of the path of the stroke.

In a further advantageous embodiment of the method according to the invention the respective times to complete each of the strokes are substantially the same. This embodiment makes it possible to have a relatively uncomplicated embodiment of an apparatus for performing the method.

In a further advantageous embodiment of the method according to the invention

the heave motion is controlled by means of a heave motion control mechanism functionally connected to the foil and configured to realize the oscillating heave motion of the foil; and

the pitch is adjusted by means of a pitch adjusting mechanism functionally connected to the foil for adjusting the pitch of the foil during the oscillation cycle of the heave motion and configured to realize an oscillating pitching motion of the foil.

In an advantageous embodiment of the method according the invention wherein a heave motion control mechanism is used, the heave motion control mechanism comprises:

a heave crank mechanism having a first crankshaft rotatable about a first axis of rotation and having a first crank pin offset relative to the first axis of rotation;

a heave connection structure which is at one end rotatable connected to the first crank pin about a second axis of rotation and at another end rotatable connected to the foil about a third axis of rotation; and

a guiding structure for guiding the oscillating heave motion of the foil.

This embodiment of the method according to the invention, and in particular the application of a crank mechanism therein, makes for a uncomplicated and robust mechanism to transform a rotation into a precise and periodic oscillating heave motion of the foil or vice versa. Furthermore, the application of a crank mechanism allows for relatively easy adjustment of the heave motion by adjusting the first crank pin offset.

In an advantageous embodiment thereof the heave connection structure comprises a first rod which is at a first end thereof rotatable connected to the first crank pin about the second axis of rotation and at a second end thereof connected to the foil. This feature provides for an uncomplicated connection structure that allows for relatively easy adjustment of the heave motion by adjusting the length of the heave connection rod. In an advantageous embodiment thereof the second end of the heave connection rod is rotatable connected to the foil about the third axis of rotation. This feature makes it possible to provide for an uncomplicated and robust realization of the heave connection structure in which the pitch connection rod is directly connected to the foil. In an alternative embodiment the heave connection structure further comprises a first parallelogram structure, which connects the second end of the heave connection rod to the foil. This feature allows for a precise extension of the motion of the second end of the first rod, such that there are more options for the arrangement of the heave crank mechanism and/or the heave connection structure relative to the foil than in case the heave connection rod is directly connected to the foil.

In a further advantageous embodiment of the method according to the invention wherein a heave motion control mechanism comprising a guiding mechanism is used, the foil is rotatable connected to the guiding structure about a fifth axis of rotation. This feature makes it possible to provide for an uncomplicated and robust guiding of translation movement of the foil while not restricting the rotational movement of the foil, thus promoting the separation of the pitch motion of the foil and the guidance of the heave motion of the foil and therewith promoting the control over the pitch motion and the heave motion of the foil. In a preferred embodiment thereof the third axis of rotation and the fifth axis of rotation coincide. This feature makes it possible to further promote the separation of the pitch motion of the foil and the guidance of the heave motion of the foil, thus promoting the control over the pitch motion and heave motion of the foil.

In a further advantageous embodiment of the method according to the invention wherein a heave motion control mechanism comprising a guiding structure is used wherein the foil is rotatable connected to the guiding structure about a fifth axis of rotation, the guiding structure comprises a guide connecting structure which is with one end rotatable connected to the foil about the fifth axis of rotation and with another end rotatable connected with a stationary point, which is stationary relative to the first axis of rotation, about a sixth axis of rotation. This feature makes it possible to provide for an uncomplicated and robust embodiment of the guiding structure. In a preferred embodiment thereof the guide connecting structure comprises a guide connection rod which is at a first end thereof rotatable connected to the foil about the fifth axis of rotation and at a second end thereof rotatable connected to the foil about the sixth axis of rotation.

In a further advantageous embodiment of the method according to the invention wherein a pitch adjusting mechanism is used, the pitch adjusting mechanism comprises:

a pitch crank mechanism having a second crankshaft rotatable about a seventh axis of rotation and having a second crank pin offset relative to the seventh axis of rotation;

a pitch connection structure which is with one end rotatable connected to the second crank pin about an eighth axis of rotation and with another end connected to the foil at a connection point offset relative to the third axis of rotation by means of a pitch adjusting lever. This embodiment of the method according to the invention, and in particular the application of a crank mechanism therein, makes for an uncomplicated and robust mechanism to transform a rotation into a precise and periodic oscillating pitch motion of the foil. Furthermore, the application of a crank mechanism allows for relatively easy adjustment of the pitch motion by adjusting the second crank pin offset.

In an advantageous embodiment of the method according to the invention wherein a pitch adjusting mechanism is used comprising a pitch crank mechanism and a pitch connection structure, the pitch connection structure comprises a second rod which is at a first end thereof rotatable connected to the second crank pin about the eighth axis of rotation and at a second end thereof rotatable connected to the foil. This feature provides for an uncomplicated connection structure that allows for relatively easy adjustment of the pitch motion by adjusting the length of the pitch connection rod.

In a preferred embodiment thereof the second end of the pitch connection rod is rotatable connected to the foil at the connection point about a ninth axis of rotation. This feature makes it possible to provide for an uncomplicated and robust realization of the heave connection structure in which the pitch connection rod is directly connected to the foil. In an alternative embodiment the pitch connection structure further comprises a second parallelogram structure, which connects the second end of the pitch connection rod to the connection point. This feature allows for a precise extension of the motion of the second end of the pitch connection rod, such that there are more options for the arrangement of the pitch crank mechanism and/or the pitch connection structure relative to the foil than in case the pitch connection rod is directly connected to the foil.

In a further advantageous embodiment of the method according to the invention wherein a heave crank mechanism and a pitch crank mechanism is used, the heave crank mechanism and the pitch crank mechanism are functionally connected such that when driven the speed of revolution of the heave crank mechanism about the first axis of rotation is the same as the speed of revolution of the pitch crank mechanism about the seventh axis of rotation. This feature makes a precise synchronization of the pitch motion and the heave motion possible. In an advantageous embodiment thereof the first axis of rotation and the seventh axis of rotation coincide. This feature provides for an uncomplicated robust functional connection of the first and pitch crank mechanism.

In a further advantageous embodiment of the method according to the invention the foil is designed such that it is flexible along the chord line thereof. This feature makes it possible to provide for a higher efficiency and a lower lift force. In an alternative or additional embodiment the foil is designed such that it is bendable along the span thereof. This feature makes it possible to provide for a higher efficiency and a lower lift force.

In a further advantageous embodiment of the method according to the invention a drive for driving at least one of the heave crank mechanism and the pitch crank mechanism is functionally connected to at least one of the heave crank mechanism and the pitch crank mechanism. This feature makes it possible to use the method according to the invention to for instance propel a vessel or to generate a whirl or flow in a fluid.

In an alternative embodiment the method according to the invention a power generator is functionally connected to at least one of the heave crank mechanism and the pitch crank mechanism. This feature makes it possible to use the method according to the invention for generating power from a fluid flow.

The invention further relates to an apparatus for performing the method according to the invention as described herein above, comprising

a heave motion control mechanism functionally connected to the foil and configured to realize an oscillating heave motion of the foil, the oscillating heave motion consisting of two strokes of the foil in opposite direction; and

a pitch adjusting mechanism functionally connected to the foil for adjusting the pitch of the foil during the oscillation cycle of the heave motion and configured to realize an oscillating pitching motion of the foil relative to the fluid;

wherein the heave motion control mechanism and the pitch adjusting mechanism are configured such that
at at least one determined inflow speed, and at at least one frequency of the oscillating heave motion, over 65% to 85% of the oscillation cycle of the heave motion for each stroke of the foil, the absolute angle of attack is more than 60% of the maximum absolute angle of attack during the stroke.

The inflow speed is the relative speed between the fluid and the apparatus as a whole, also known as velocity of advance.

In an advantageous embodiment of the apparatus according to the invention 65% to 85% of the oscillation cycle of the heave motion is 65% to 85% of the time to complete one cycle of the heave motion. In an alternative embodiment the 65% to 85% of the oscillation cycle of the heave motion is 65% to 85% of the path of the foil during one cycle of the heave motion.

In an advantageous embodiment of the apparatus according to the invention for each stroke of the foil, the absolute angle of attack is more than 60% of the maximum absolute angle of attack during the stroke over 65% to 85% of the stroke. Preferably, the absolute angle of attack is more than 60% of the maximum absolute angle of attack during the stroke over 65% to 85% of the time to complete the stroke. Alternatively, the absolute angle of attack is more than 60% of the maximum absolute angle of attack during the stroke over 65% to 85% of the path of the stroke.

In a further advantageous embodiment of the apparatus according to the invention the respective times to complete each of the strokes are substantially the same.

Further advantageous embodiments of the heave control mechanism and the pitch adjusting mechanism of the apparatus according to the invention are described hereinabove with respect to the method according to the invention.

The invention further relates to a vessel comprising a hull, and an apparatus according to the invention having a drive for driving at least one of the heave crank mechanism and the pitch crank mechanism, wherein at least the foil is located outside the hull. In an embodiment of the vessel according to the invention the at least one determined inflow speed is a design speed of the vessel, and the at least one frequency of the oscillating heave motion the design frequency for said design speed.

The invention further relates to an installation for generating energy from a flow of fluid, such as water in a river, comprising an apparatus according to the invention having a power generator functionally connected to at least one of the heave crank mechanism and the pitch crank mechanism, wherein at least the foil is located in the flow of fluid. In an embodiment of the installation for generating energy from a flow of fluid according to the invention the at least one determined inflow speed is a design flow speed of the fluid the installation is designed for, and the at least one frequency of the oscillating heave motion the design frequency for said design flow speed.

The invention further relates to an installation for generating a flow or whirl in a fluid, such as a mixer or a pump, comprising an apparatus according to the invention having a drive for driving at least one of the heave crank mechanism and the pitch crank mechanism, wherein at least the foil is located in the fluid in which the flow or whirl is to be generated. In an embodiment of the installation for generating a flow or whirl in a fluid according to the invention the at least one determined inflow speed is a design flow speed of the fluid the installation is designed to generate, and the at least one frequency of the oscillating heave motion the design frequency for said design flow speed.

The invention further relates to an installation, comprising at least two functionally connected apparatuses according to the invention, wherein the apparatus are out of phase with each other. This feature makes it possible to achieve a more smoothed flow downstream of the foil and a more smoothed torque at the drive or generator.

The present invention will be further elucidated herein after on the basis of exemplary embodiments, which are shown schematically in the accompanying figures. These are non limitative exemplary embodiments. In the figures features with the same reference sign are the same. In the figures:

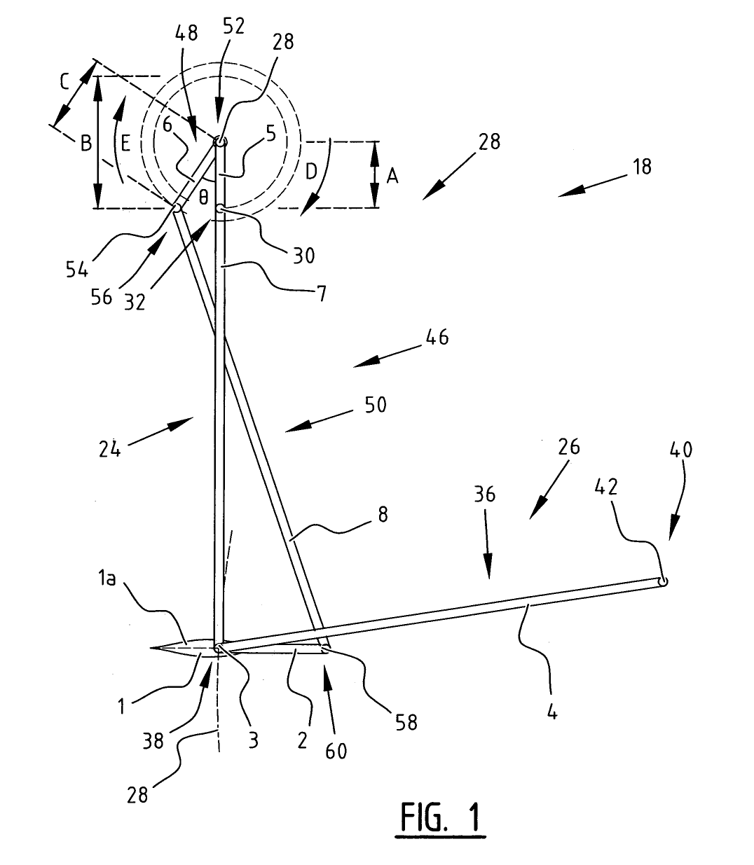

FIG. 1 shows a schematic representation of an embodiment of the apparatus according to the invention;

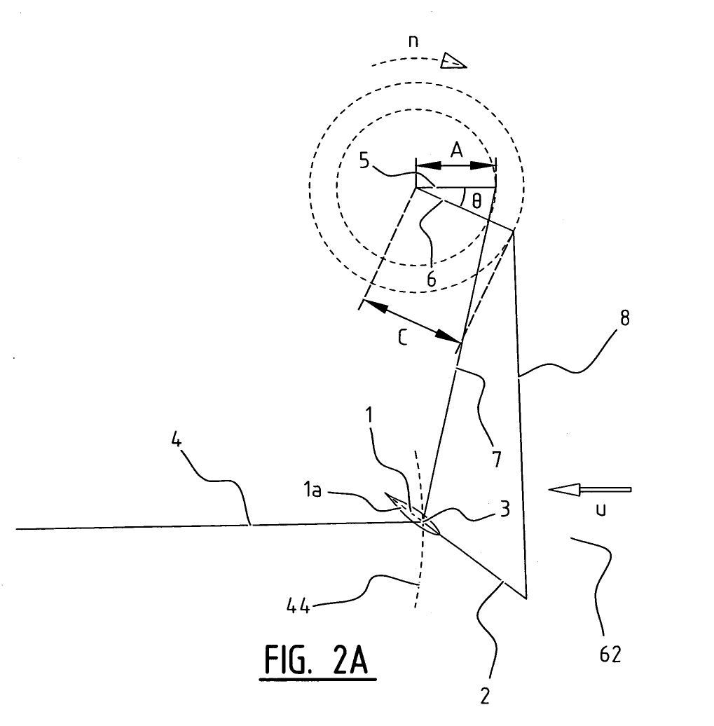

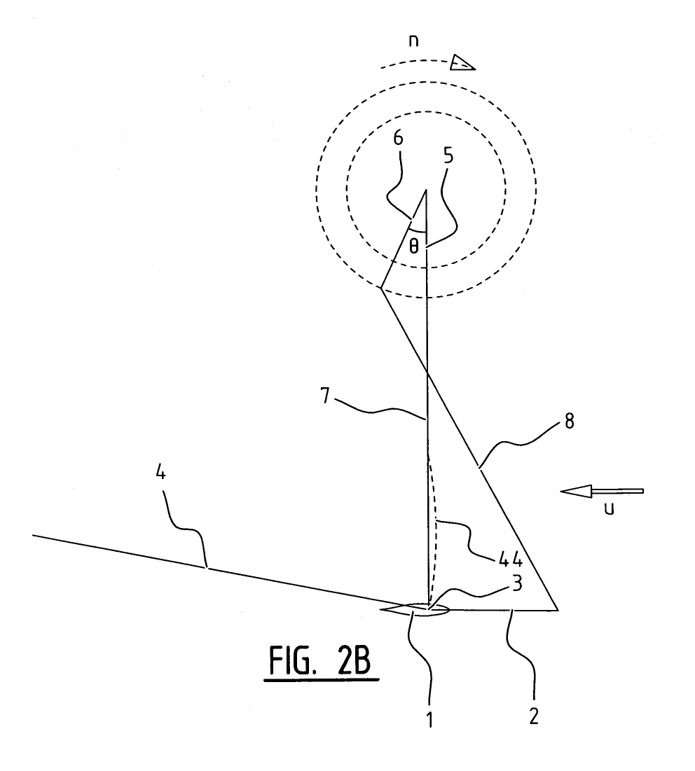

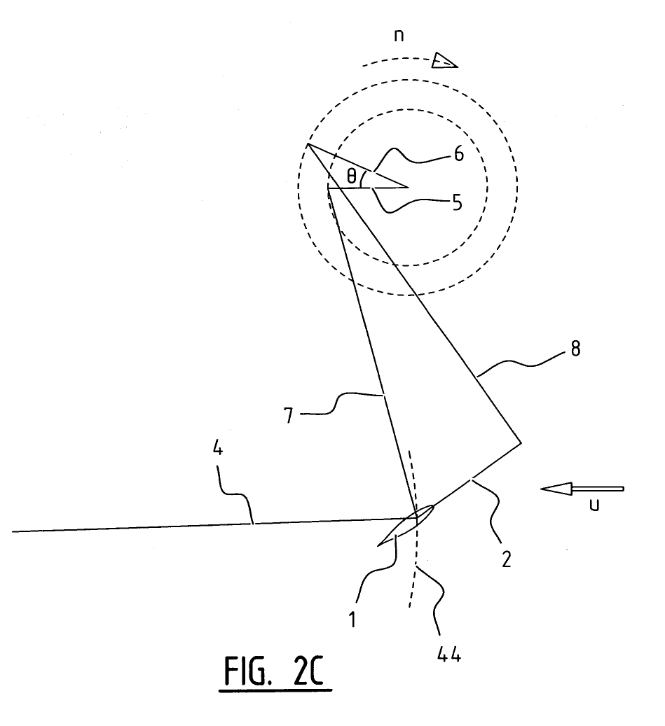

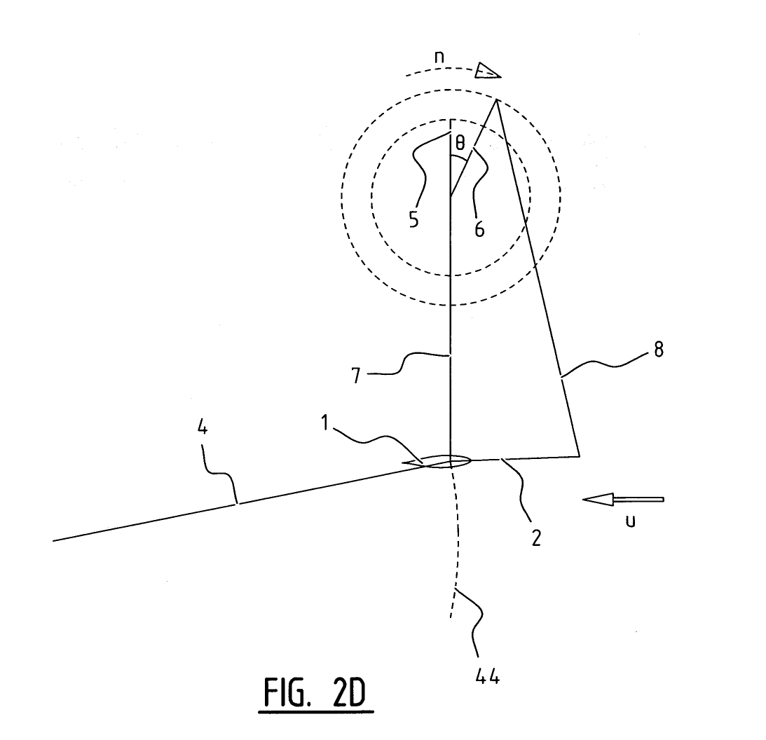

FIGS. 2A to 2D show a wire-frame model of the embodiment of the apparatus 18 for oscillating a foil shown in FIG. 1 in four subsequent moments in time of one cycle of the heave motion of the foil in a fluid;

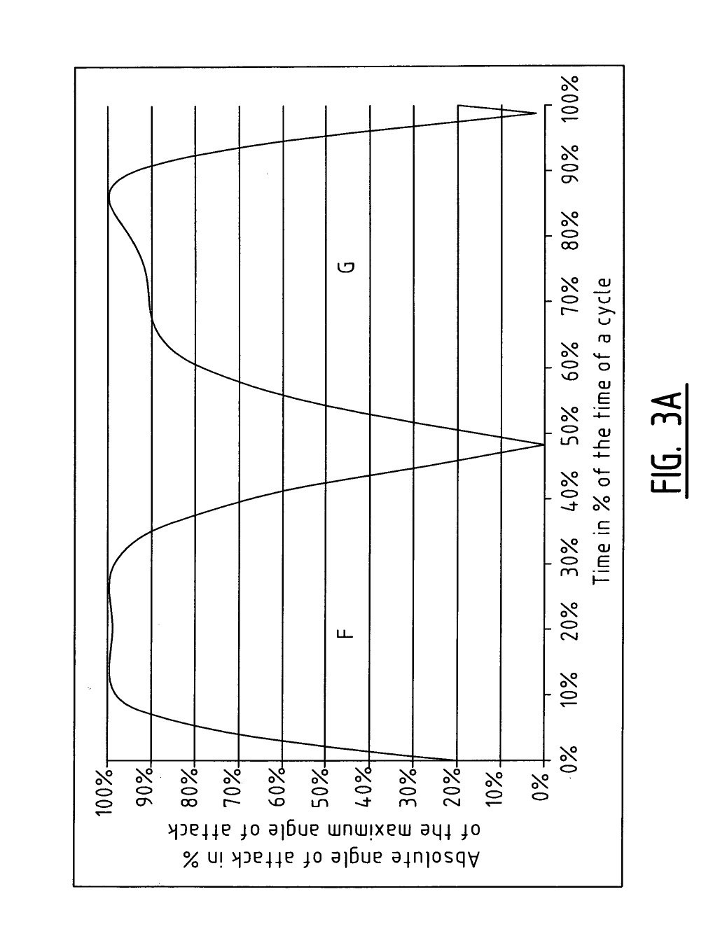

FIGS. 3A and 3B show the angle of attack as a percentage of the maximum absolute angle of attack set out against the time in percentage of the time of a oscillation cycle of the heave motion as a result of performing the method according to the invention;

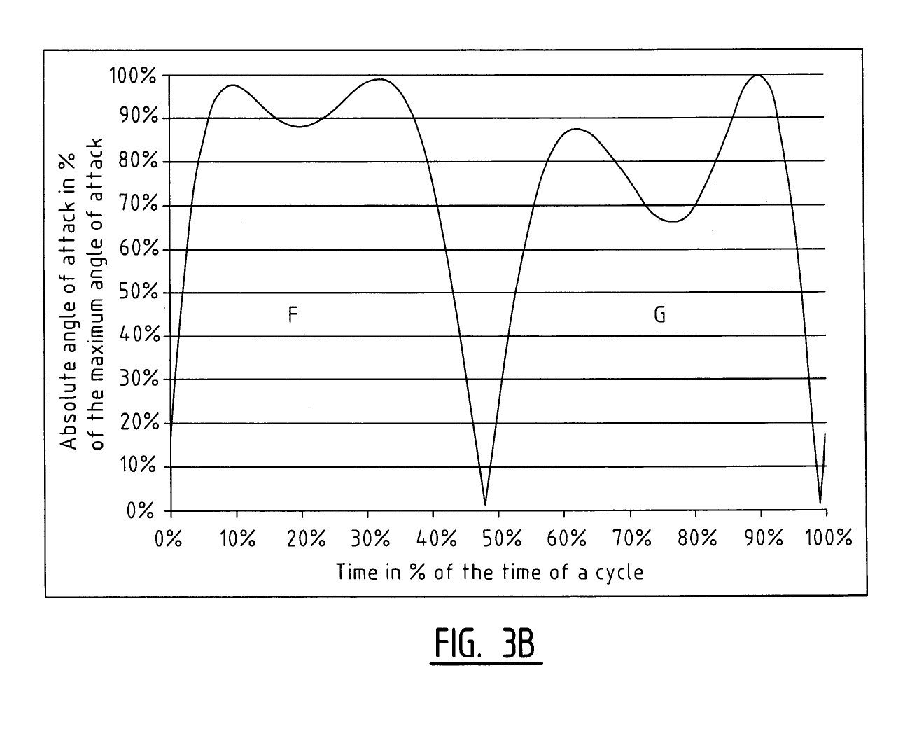

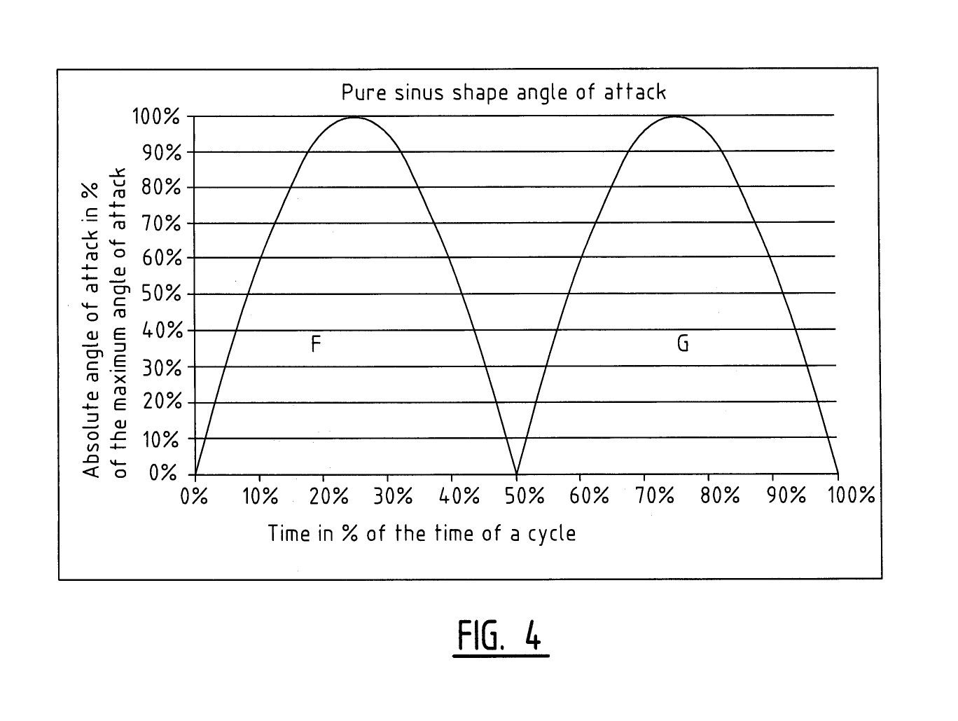

FIG. 4 shows the angle of attack as a percentage of the maximum absolute angle of attack set out against the time in percentage of the time of a oscillation cycle of the heave motion as a result of performing a known method aimed at achieving a sinus shape motion of the Angle of Attack;

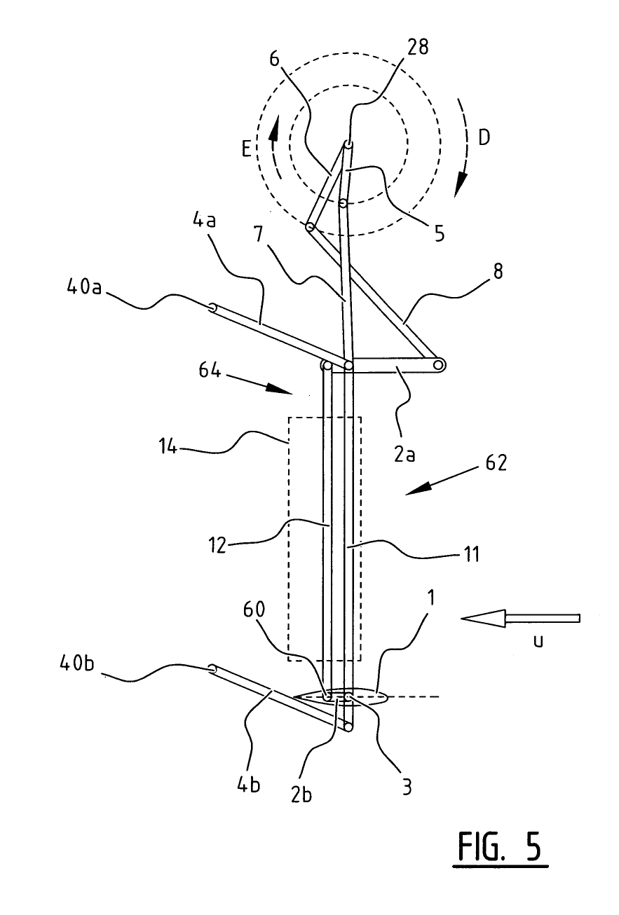

FIG. 5 shows a schematic representation of an alternative embodiment of the apparatus of FIG. 1;

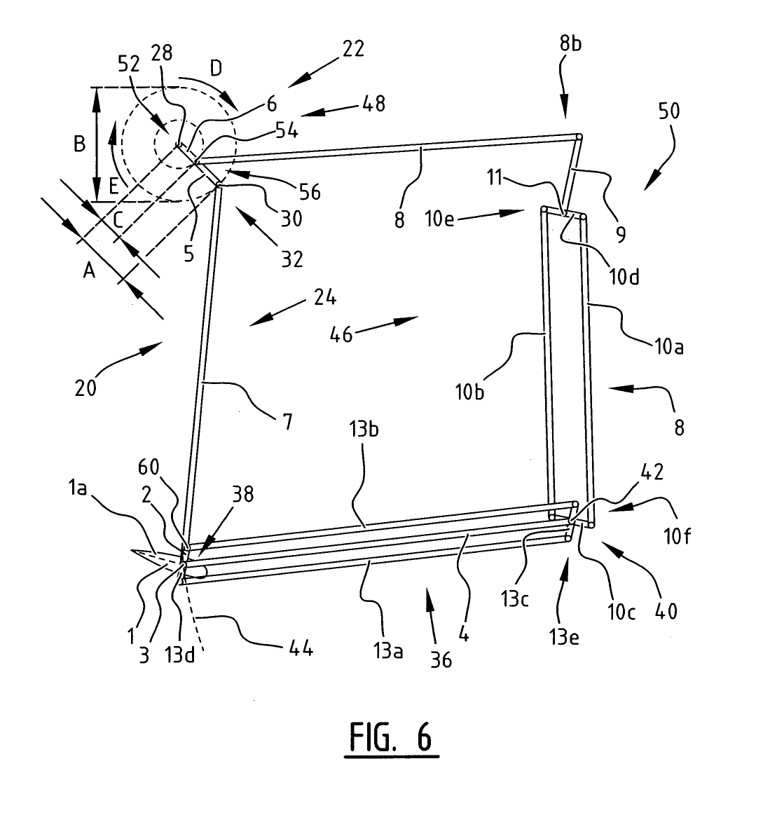

FIG. 6 shows a schematic representation of a further alternative embodiment of the apparatus of FIG. 1;

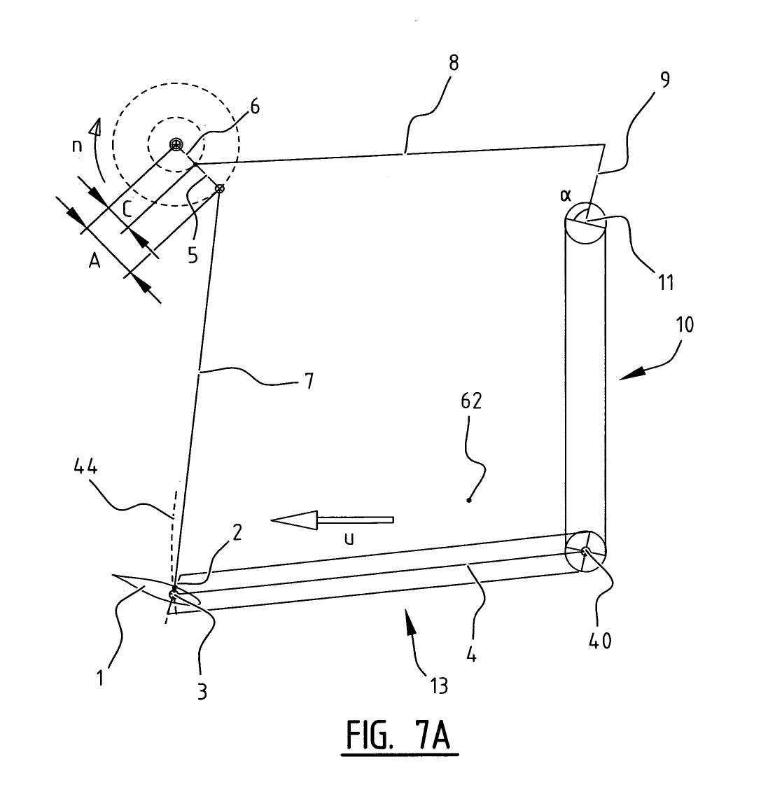

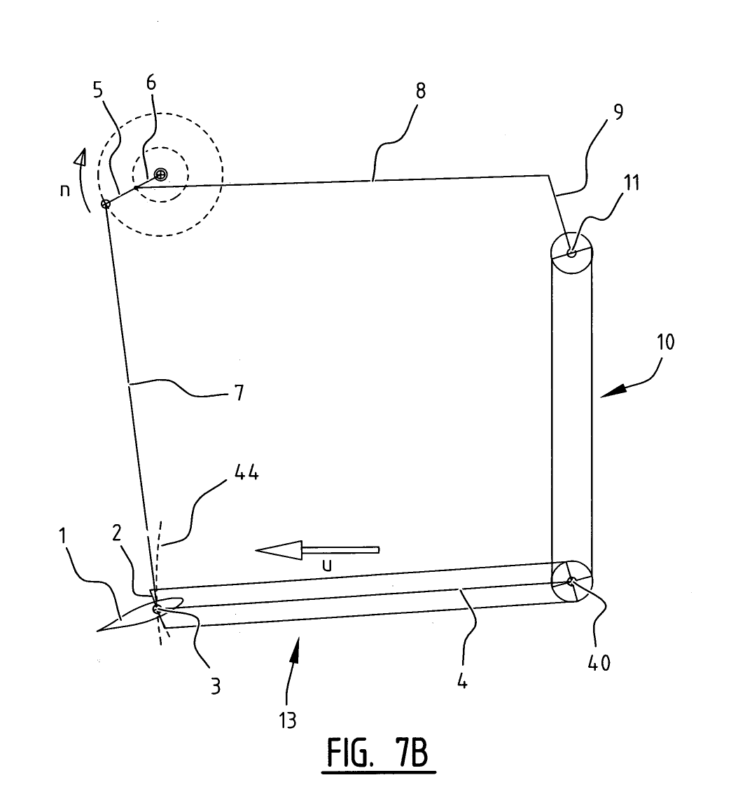

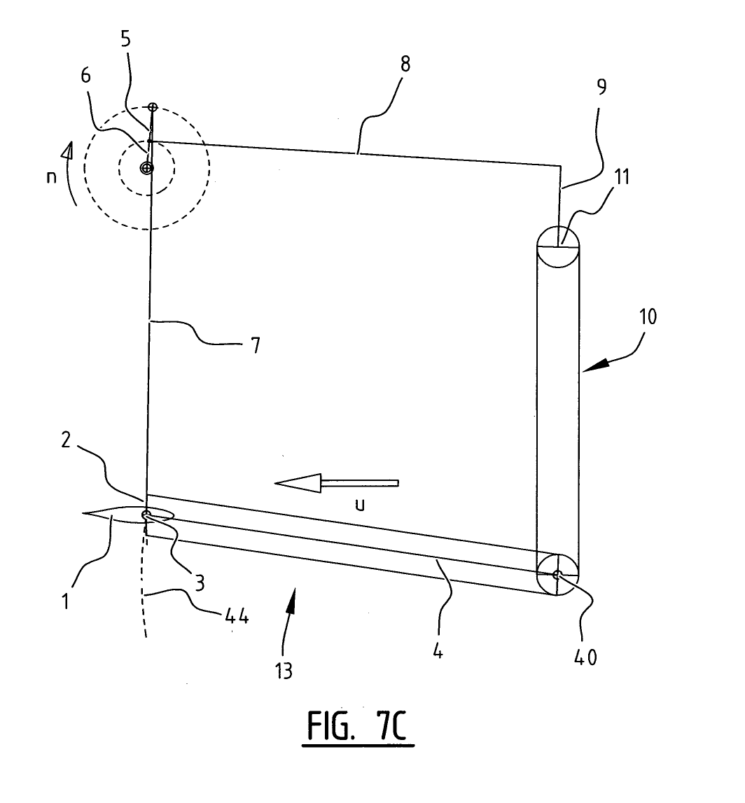

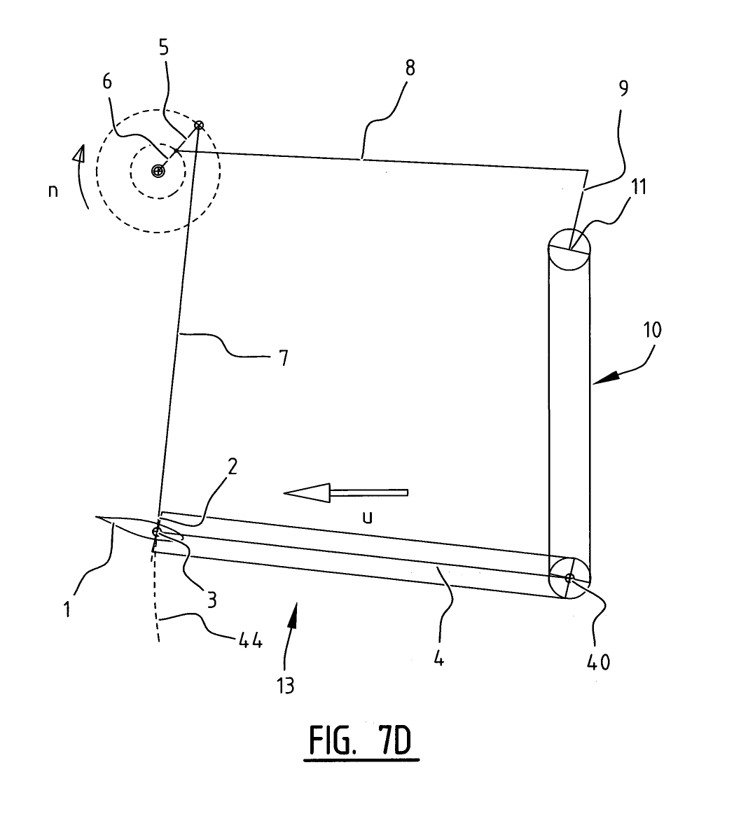

FIGS. 7A to 7D show a wire-frame model of the embodiment of the apparatus for oscillating a foil shown in FIG. 6 in four subsequent moments in time of one cycle of the heave motion of the foil in a fluid;

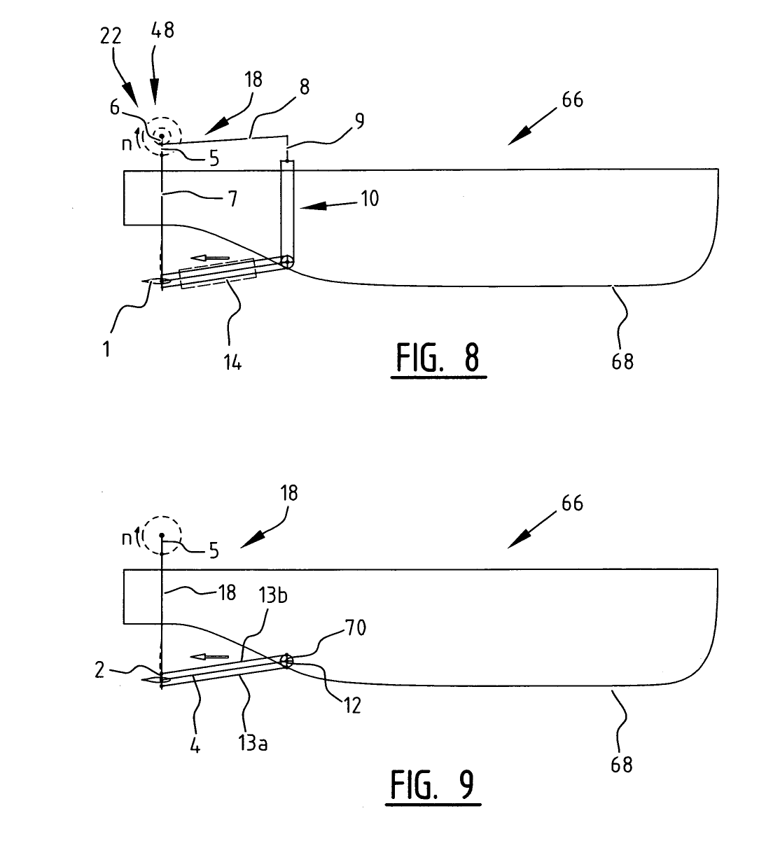

FIG. 8 shows a vessel with a hull and the embodiment of the apparatus according to the invention of FIG. 6;

FIG. 9 shows a schematic representation of an alternative embodiment of the embodiment of the apparatus according to the invention as shown in FIG. 8;

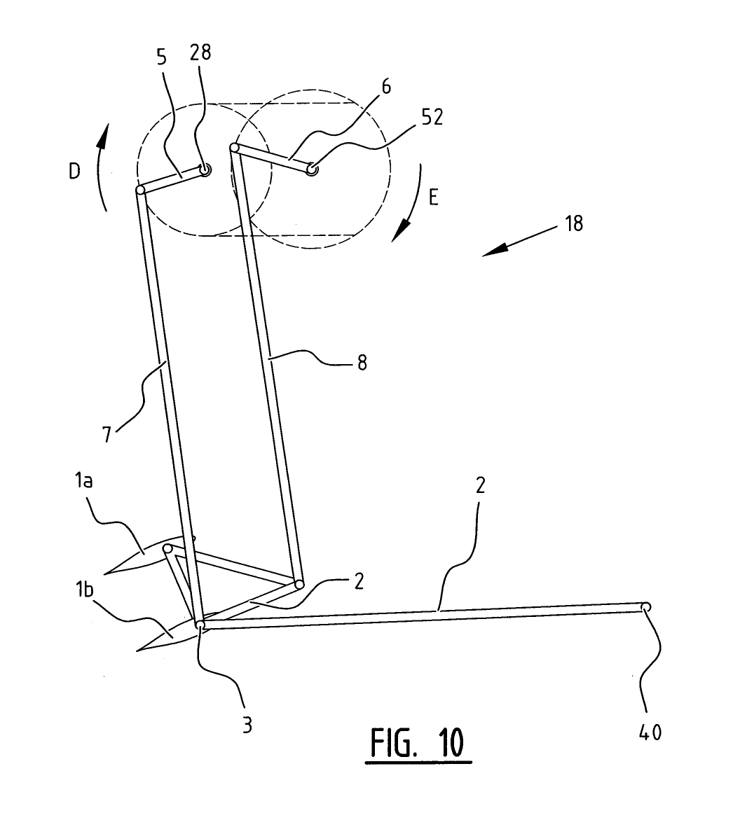

FIGS. 10, 11 and 12 show a schematic representation of further alternative embodiments of the apparatus according to the invention as shown in FIGS. 1 to 9.

FIG. 1 shows an embodiment of the apparatus according to the invention.

The apparatus 18 shown in FIG. 1 has a heave motion control mechanism 20 functionally connected to the foil 1 which is configured to realize an oscillating heave motion of the foil 1 having a cord line 1a, the oscillating heave motion consisting of two strokes of the foil in opposite direction. The heave motion control mechanism 20 is shown with a heave crank mechanism 22, a heave connection structure 24, and a guiding structure 26. Shown in FIG. 1 is a two-dimensional representation of the foil 1.

The heave crank mechanism 22 is shown with a first crankshaft 5, also referred to as power crank, rotatable about a first axis of rotation 28 and having a first crank pin 30 offset relative to the first axis of rotation 28 over a crank pin offset forming distance A.

The crank mechanism is connected to the foil 1 by means of the heave connection structure 24, which is shown with a heave connection rod 7, also referred to as power rod, which is at a first end thereof rotatable connected to the first crank pin 30 about a second axis of rotation 32 and at a second end thereof rotatable connected to the foil 1 about a third axis of rotation 3.

The guiding structure 26 serves for guiding the oscillating heave motion of the foil 1, and comprises a guide connection structure 36 having a guide connection rod 4, also referred to as kite rod, which is at a first end thereof rotatable connected to the foil about a fifth axis of rotation 38, which coincides with the third axis of rotation 34, and at a second end thereof rotatable connected a stationary point 40, which is stationary relative to the first axis of rotation 28, about a sixth axis of rotation 42. The first axis of rotation 3, being the rotation point of the foil 1, is restricted in movement by a partial circular curve 44 defined by the guide connection rod 4 and the stroke B of the first crankshaft 5.

The apparatus 18 shown in FIG. 1 further has a pitch adjusting mechanism 46 functionally connected to the foil 1 for adjusting the pitch of the foil during the oscillation cycle of the heave motion and configured to realize an oscillating pitching motion of the foil 1. The pitch control mechanism 46 is shown with a pitch crank mechanism 48, and a pitch connection structure 50.

The pitch crank mechanism 48 is shown with a second crankshaft 6 rotatable about a seventh axis of rotation 52 and having a second crank pin 54 offset relative to the seventh axis of rotation 52 over a crank pin offset forming distance C. The seventh axis of rotation 52 coincides with the first axis of rotation 28, and the heave crank mechanism 5 and the pitch crank mechanism 6 are functionally connected such that when driven the speed of revolution D of the heave crank mechanism 22 about the first axis of rotation 28 is the same as the speed of revolution E of the pitch crank mechanism 48 about the seventh axis of rotation 52. Further as shown in FIG. 1 there is a phase difference θ between the first crankshaft 5 and the second crankshaft 6.

The pitch connection structure 50 is shown with a pitch connection rod 8, also referred to as pitch adjusting rod, which is at a first end thereof rotatable connected to the second crank pin 54 about an eighth axis of rotation 56 and at a second end thereof rotatable connected to the foil about a ninth axis of rotation 58 at a connection point 60 offset relative to the third axis of rotation 3 by means of a pitch adjusting lever 2.

FIGS. 2A to 2D show a wire-frame model of the embodiment of the apparatus 18 for oscillating a foil 1 shown in FIG. 1 in four subsequent moments in time of one cycle of the heave motion of the foil 1 in a fluid 62. Shown in FIG. 2A to 2D is a two-dimensional representation of the foil 1. In FIGS. 2A to 2D the apparatus 18 as a whole is stationary, while the fluid flows with a determined flow speed relative to the apparatus as a whole. The arrow U represents the inflow speed, being the relative speed between the fluid and the apparatus as a whole.

In the apparatus as shown in FIGS. 1 and 2:
the heave crank pin offset A and the second crank pin offset C, the second crank pin offset C being greater than the first crank pin offset A, are adjusted;
the phase offset θ between the heave crankshaft 5 and the pitch crankshaft 6, is adjusted;
the length of the heave connection rod 7 is adjusted; and
the length of the pitch connection rod 8 is adjusted;
   such that at a certain inflow speed U and a certain rotation speed n of the crankshafts, the rotation speed being a representation of the frequency of the generated heave motion, the foil 1 will oscillate in that way that, as shown in FIG. 3A wherein the angle of attack as a percentage of the maximum absolute angle of attack set out against the time in percentage of the time of an oscillation cycle of the heave motion, over 65% to 85% of the oscillation cycle of the heave motion for each stroke F, G of the foil, the absolute angle of attack is more than 60% of the maximum absolute angle of attack during the stroke.

In particular in FIG. 3A is shown that for each stroke F, G of the foil, the absolute angle of attack is more than 60% of the maximum absolute angle of attack during the stroke over 65% to 85% of the time to complete the stroke, and that the respective times to complete each of the strokes are substantially the same. For each stroke, the curve is a flattened curve.

Another example of a flattened curve of angle of attack as a percentage of the maximum absolute angle of attack set out against the time in percentage of the time of a oscillation cycle of the heave motion, wherein over 65% to 85% of the oscillation cycle of the heave motion for each stroke of the foil, the absolute angle of attack is more than 60% of the maximum absolute angle of attack during the stroke, is shown in FIG. 3B. As in FIG. 3A, in FIG. 3B is shown that for each stroke F, G of the foil, the absolute angle of attack is more than 60% of the maximum absolute angle of attack during the stroke over 65% to 85% of the time to complete the stroke, and that the respective times to complete each of the strokes are substantially the same.

In both FIGS. 3A and 3B, for each stroke F, G, the curve is a flattened curve relative to the curve as shown in FIG. 4. FIG. 4 shows the angle of attack as a percentage of the maximum absolute angle of attack set out against the time in percentage of the time of a oscillation cycle of the heave motion as a result of performing a known method aimed at achieving a sinus shape motion of the Angle of Attack. The angle of attack has values of more than 60% of the maximum angle of attack per stroke F, G, of the foil over 59.4% of the cycle, where a cycle is the up and the down stroke of the foil.

In FIG. 5 is an alternative embodiment of the apparatus 18 according to the invention as shown in FIG. 1 is shown. The apparatus as shown in FIG. 5 differs from the apparatus as shown in FIG. 1 in that the second ends of respectively the heave connection rod 7 and the pitch connection rod 8 are not directly connected to the foil 1 but via respectively a heave parallelogram structure 62 and a pitch parallelogram structure 64. Shown in FIG. 5 is a two-dimensional representation of the foil 1.

The heave parallelogram structure 62, consists of the rotatable interconnected rods 4a, 4b, and 11, connects the second end of the heave connection rod 7 to the foil 1. The pitch parallelogram structure 64, i.e. the pitch parallelogram, consisting of the rotatable interconnected rods 2a, 11, 12, and the pitch adjusting lever 2b, connects the second end of the pitch connection rod 8 to the connection point. Since the rods 11 and 12 remain parallel throughout the oscillating heave motion of the foil 1, a schematically shown streamlined enclosure 14 can be arranged around the rods 11 and 12 to reduce the drag of the rods 11 and 12 in the fluid.

In FIG. 6 an alternative embodiment is shown of the apparatus according to the invention as shown in FIG. 1.

The apparatus 18 shown in FIG. 6 has a heave motion control mechanism 20 functionally connected to the foil 1 which is configured to realize an oscillating heave motion of the foil 1 having a cord line 1a, the oscillating heave motion consisting of two strokes of the foil 1 in opposite direction. Shown in FIG. 6 is a two-dimensional representation of the foil 1.

The heave motion control mechanism 20 is shown with a heave crank mechanism 22, a heave connection structure 24, and a guiding structure 26.

The heave crank mechanism 22 is shown with a heave crankshaft 5, also referred to as power crank, rotatable about a first axis of rotation 28 and having a first crank pin 30 offset relative to the first axis of rotation 28 over a crank pin offset forming distance A.

The heave crank mechanism 22 is connected to the foil 1 by means of the heave connection structure 24, which is shown with a heave connection rod 7, also referred to as power rod, which is at a first end thereof rotatable connected to the first crank pin 30 about a second axis of rotation 32 and at a second end thereof rotatable connected to the foil 1 about a third axis of rotation 3.

The guiding structure 26 serves for guiding the oscillating heave motion of the foil 1, and comprises a guide connection structure 36 having a guide connection rod 4, also referred to as kite rod, which is at a first end thereof rotatable connected to the foil 1 about a fifth axis of rotation 38, which coincides with the third axis of rotation 3, and at a second end thereof rotatable connected a stationary point 40, which is stationary relative to the first axis of rotation 28, about a sixth axis of rotation 42. The first axis of rotation 3, being the rotation point of the foil 1, is restricted in movement by a partial circular curve 44 defined by the guide connection rod 4 and the stroke B of the first crankshaft 5.

The apparatus shown in FIG. 6 further has a pitch adjusting mechanism 46 functionally connected to the foil 1 for adjusting the pitch of the foil 1 during the oscillation cycle of the heave motion and configured to realize an oscillating pitching motion of the foil 1. The pitch control mechanism 46 is shown with a pitch crank mechanism 48, and a pitch connection structure 50.

The pitch crank mechanism 48 is shown with a second crankshaft 6 rotatable about a seventh axis of rotation 52 and having a pitch crank pin 54 offset relative to the seventh axis of rotation 52 over a crank pin offset forming distance C. The seventh axis of rotation 52 coincides with the first axis of rotation 28, and the heave crank mechanism 22 and the pitch crank mechanism 48 are functionally connected such that when driven the speed of revolution D of the heave crank mechanism 22 about the first axis of rotation 28 is the same as the speed of revolution E of the pitch crank mechanism 48 about the seventh axis of rotation 52. Further as shown in FIG. 6 there is no phase difference between the heave crankshaft 5 and the pitch crankshaft 6.

The pitch connection structure 50 has a pitch connection rod 8, also referred to as pitch adjusting rod, which is at a first end thereof rotatable connected to the pitch crank pin 54 about an eighth axis of rotation 56 and at a second end thereof rotatable connected to the foil 1 by means of a pitch parallelogram structure 64. The pitch parallelogram structure 64 is shown having a lever rod 9, a first parallelogram 10 comprising rotatable interconnected rods 10a to 10d, and a second parallelogram 13 comprising rotatable interconnected rods 13a to 13d. The lever rod 9 connects the second end 8b of the pitch connection rod 8 to a first end 10e of the first parallelogram 10 at a point 11 stationary relative to the first axis of rotation 28. The second end 10f of the first parallelogram 10 is connected to the first end 133 of the second parallelogram 13 at the stationary point 40 to which point the guide connection rod 4 is connected. The second end 13f of the second parallelogram 13 is connected to the foil 1. As such the pitch parallelogram structure 64 connects the second end 8b of the pitch connection rod 8 to the connection point 60 offset relative to the third axis of rotation 3 by means of the pitch adjusting lever 2.

The function of the guide connecting rod 4 is to transfer the vertical forces of the foil to the stationary point 12, but this function can be taken by the second parallelogram 13 as well.

In FIGS. 7A to 7D show a wire-frame model of the embodiment of the apparatus 18 for oscillating a foil 1 shown in FIG. 6 in four subsequent moments in time of one cycle of the heave motion of the foil 1 in a fluid 62. Shown in FIGS. 7A to 7D is a two-dimensional representation of the foil 1. In FIGS. 7A to 7D the apparatus 18 as a whole is stationary, while the fluid flows with a determined flow speed relative to the apparatus as a whole. The arrow U represents the inflow speed, being the relative speed between the fluid and the apparatus as a whole.

In the apparatus 18 as shown in FIGS. 6 and 7:
the heave crank pin offset A and the pitch crank pin offset C are adjusted;
the phase offset θ between the heave crankshaft 5 and the pitch crankshaft 6, is adjusted;
the length of the pitch connection rod 8 is adjusted;
the length of the lever rod 9 is adjusted;
the angle α between the lever rod 9 and the first parallelogram 10 is adjusted; and
the location of the fixed rotation point 11 connecting the lever 9 and the first parallelogram 10 is adjusted, such that at a certain inflow speed U and a certain rotation speed n of the crankshafts, the rotation speed being a representation of the frequency of the generated heave motion, the foil 1 will oscillate in that way that, as shown in FIGS. 3A and 3B wherein the angle of attack as a percentage of the maximum absolute angle of attack set out against the time in percentage of the time of a oscillation cycle of the heave motion is shown, over 65% to 85% of the oscillation cycle of the heave motion, for each stroke F, G, of the foil, the absolute angle of attack is more than 60% of the maximum absolute angle of attack during the stroke F, G.

In FIG. 8 a vessel 66 is shown having a hull 68 and the apparatus 18 of FIG. 6, wherein the foil 1 is located outside the hull 68. The apparatus 18 comprises a drive (not shown) for driving the heave crank mechanism 22 and the pitch crank mechanism 48 such that the heave crank mechanism 22 and the pitch crank mechanism 48 are given a certain rotation speed n.

The second parallelogram 13 can be placed in a streamlined enclosure 14 (schematically shown) to reduce the drag of the rods of the second parallelogram 13. The streamlined enclosure 14 can be embodied by a hollow guide connection rod 4.

The part of the pitch connection structure 50, e.g. components 8, 9, 10, between the second crankshaft 6 and the second parallelogram 13 is located inside the vessel 66, resulting in an uncomplicated mechanism with low disturbance of the inflow to the foil.

In FIG. 9 an alternative embodiment is shown of the apparatus 18 according the invention as shown in FIG. 8. In the apparatus as shown in FIG. 9 the pitch adjusting mechanism 50 comprises the pitch adjusting lever 2 which is connected to two rods 13a, 13b and another lever 70 forming the pitch parallelogram 13 to adjust the pitch of the foil 1. The adjustment of the parallelogram 13 is done at the site of the fixed rotation point 12 of the guide connection rod 4 via a known means like an electromotor, or a cylinder. Instead of rods 13a, 13b a chain or cables can be used to form the parallelogram 13.

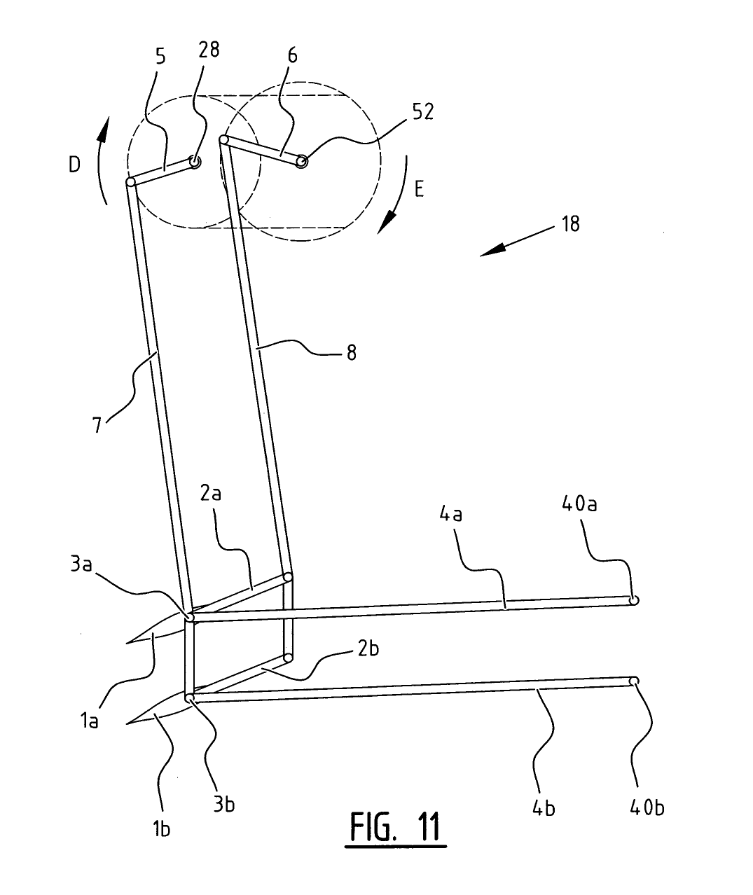

Instead of one foil 1 per apparatus 18 as shown in FIGS. 1 to 9, more than one foil 1a, 1b per apparatus 18 may be applied like in FIG. 10 and FIG. 11. Also shown in FIGS. 10 and 11 is the possibility that the first axis of rotation 28 and the seventh axis of rotation 52 do not coincide.

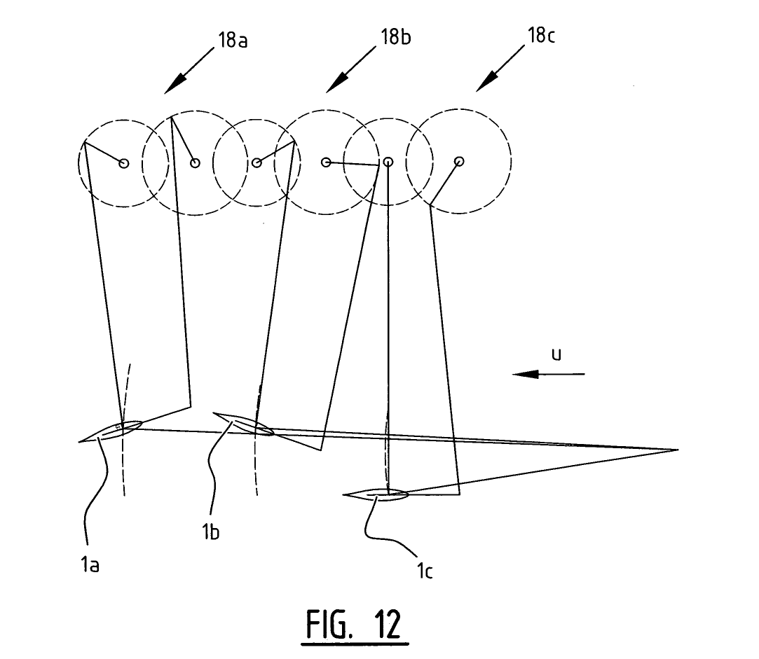

As shown in FIG. 12 more than one apparatus 18a, 18b, 18c can be connected to each other with a phase difference:

to get a less oscillating pulse;

to induce an oscillating pulse by one of the foils while the other is in top or bottom;

to increase the efficiency by reducing the trust load per blade.

In FIGS. 3A and 3B is shown that for each stroke of the foil, the absolute angle of attack is more than 60% of the maximum absolute angle of attack during the stroke over 65% to 85% of the time to complete the stroke, and that the respective times to complete each of the strokes are substantially the same. For each stroke, the curve is a flattened curve. It could also be that not for each stroke of the foil, the absolute angle of attack is more than 60% of the maximum absolute angle of attack during the stroke over 65% to 85% of the stroke, while sto over 65% to 85% of the oscillation cycle of the heave motion, for each stroke of the foil, the absolute angle of attack is more than 60% of the maximum absolute angle of attack during the stroke. In that case for instance only the curve of one of the strokes can be flattened. Furthermore, the respective times to complete each of the strokes could also differ.

The rotation direction for both of the two crankshafts 5 and 6 as shown in FIGS. 1 to 12 is clockwise. Other variations of the rotation direction of the cranks with the principles of the inventions can be applied as well, such as the rotation direction of the two crankshafts 5 and 6 being counter clockwise, or the rotation of one of the crankshafts being clockwise and the other counter clockwise.

In the figures the foil has a symmetrical foil shape, but it could take other forms while sto acting as a lifting surface, including a simple flat plate, a foil with an active tail flap or an eye shaped profile.

In the figures the guiding structure is formed as a connecting structure comprising a number of rods connecting the foil to a point that is stationary relative to the first axis of rotation. However, the guide structure could for instance also be formed as a rail structure along which the third axis of rotation moves during the heave motion of the foil.

In the figures the heave control mechanism has a heave crank mechanism. Instead of a heave crank mechanism also a linear displacement mechanism could be used to generate and or control the heave motion of the foil, such as a linear motor or a linear hydraulic or pneumatic cylinder.

It will be obvious, that only a few possible embodiments of the apparatus according to the invention have been shown in the drawings and described in the inventions and that, as already indicated in the descriptions of the inventions, changes can be made without departing from the inventive idea, as it has been indicated in the claims.

1. Method for oscillating a foil in a fluid, comprising the steps of:
generating an oscillating heave motion of the foil in the fluid, the oscillation cycle of the heave motion consisting of two strokes of the foil in opposite direction;
generating an oscillating pitching motion of the foil in the fluid;
controlling the heave motion; and
adjusting the pitch during the oscillation cycle of the heave motion;
such that over 65% to 85% of the oscillation cycle of the heave motion, for each stroke of the foil, the absolute angle of attack is more than 60% of the maximum absolute angle of attack during the stroke.

2. Method according to claim 1, wherein 65% to 85% of the oscillation cycle of the heave motion is one of:
65% to 85% of the time to complete one cycle of the heave motion; and
65% to 85% of the path of the foil in one cycle of the heave motion.

3. Method according to claim 1, wherein for each stroke of the foil, the absolute angle of attack is more than 60% of the maximum absolute angle of attack during the stroke over 65% to 85% of the stroke;
preferably one of
over 65% to 85% of the time to complete the stroke; and
over 65% to 85% of the path of the stroke.

4. Method according to claim 2, wherein the respective times to complete each of the strokes are substantially the same.

5. Method according to claim 1, wherein the heave motion is controlled by means of a heave motion control mechanism functionally connected to the foil and configured to realize the oscillating heave motion of the foil; and the pitch is adjusted by means of a pitch adjusting mechanism functionally connected to the foil for adjusting the pitch of the foil during the oscillation cycle of the heave motion and configured to realize an oscillating pitching motion of the foil.

6. Method according to claim 5, wherein the heave motion control mechanism comprises:
a heave crank mechanism having a first crankshaft rotatable about a first axis of rotation and having a first crank pin offset relative to the first axis of rotation;
a heave connection structure which is at one end rotatable connected to the first crank pin about a second axis of rotation and at another end rotatable connected to the foil about a third axis of rotation; and
a guiding structure for guiding the oscillating heave motion of the foil.

7. Method according to claim 6, wherein the heave connection structure comprises a heave connection rod which is at a first end thereof rotatable connected to the first crank pin about the second axis of rotation and at a second end thereof connected to the foil.

8. Method according to claim 7, wherein the second end of the heave connection rod is rotatable connected to the foil about the third axis of rotation.

9. Method according to claim 7, wherein the heave connection structure further comprises a first parallelogram structure, which connects the second end of the heave connection rod to the foil.

10. Method according to claim 6, wherein the foil is rotatable connected to the guiding structure about a fifth axis of rotation, wherein preferably the third axis of rotation and the fifth axis of rotation coincide.

11. Method according to claim 10, wherein the guiding structure comprises a guide connecting structure which is with one end rotatable connected to the foil about the fifth axis of rotation and with another end rotatable connected with a stationary point, which is stationary relative to the first axis of rotation, about a sixth axis of rotation, wherein preferably the guide connecting structure comprises a guide connection rod which is at a first end thereof rotatable connected to the foil about the fifth axis of rotation and at a second end thereof rotatable connected to the stationary point the sixth axis of rotation.

12. Method according to claim 5, wherein the pitch adjusting mechanism comprises:
a pitch crank mechanism having a second crankshaft rotatable about a seventh axis of rotation and having a second crank pin offset relative to the seventh axis of rotation;
a pitch connection structure which is with one end rotatable connected to the second crank pin about an eighth axis of rotation and with another end connected to the foil at a connection point offset relative to the third axis of rotation by means of a pitch adjusting lever.

13. Method according to claim 12, wherein the pitch connection structure comprises a pitch connection rod which is at a first end thereof rotatable connected to the second crank pin about the eighth axis of rotation and at a second end thereof rotatable connected to the foil.

14. Method according to claim 13, wherein the second end of the pitch connection rod is rotatable connected to the foil at the connection point about a ninth axis of rotation.

15. Method according to claim 13, wherein the pitch connection structure further comprises a second parallelogram structure, which connects the second end of the pitch connection rod to the connection point.

16. Method according to claim 6, wherein the heave crank mechanism and the pitch crank mechanism are functionally connected such that when driven the speed of revolution of the heave crank mechanism about the first axis of rotation is the same as the speed of revolution of the pitch crank mechanism about the seventh axis of rotation.

17. Method according to claim 16, wherein the first axis of rotation and the seventh axis of rotation coincide.

18. Method according to claim 1, wherein the foil is designed such that it is flexible along the chord line thereof.

19. Method according to claim 1, wherein the foil is designed such that it is bendable along the span thereof.

20. Method according to claim 1, wherein a drive for driving at least one of the heave crank mechanism and the pitch crank mechanism is functionally connected to at least one of the heave crank mechanism and the pitch crank mechanism.

21. Method according to claim 1, wherein a power generator is functionally connected to at least one of the first crank and the second crank.

22. Apparatus for performing the method according to claim 1, comprising:
a heave motion control mechanism functionally connected to the foil and configured to realize an oscillating heave motion of the foil, the oscillating heave motion consisting of two strokes of the foil in opposite direction; and
a pitch adjusting mechanism functionally connected to the foil for adjusting the pitch of the foil during the oscillation cycle of the heave motion and configured to realize an oscillating pitching motion of the foil relative to the fluid;
wherein the heave motion control mechanism and the pitch adjusting mechanism are configured such that at at least one determined inflow speed, and at at least one frequency of the oscillating heave motion, over 65% to 85% of the oscillation cycle of the heave motion for each stroke of the foil, the absolute angle of attack is more than 60% of the maximum absolute angle of attack during the stroke.

23. Vessel, comprising:
a hull; and
an apparatus according to claim 22, wherein at least the foil is located outside the hull,
wherein the apparatus comprises a drive for driving at least one of the heave crank mechanism and the pitch crank mechanism.

24. Installation for generating energy from a flow of fluid, such as water in a river, comprising an apparatus according to claim 22, wherein at least the foil is located in the flow of fluid wherein the apparatus comprises a power generator functionally connected to at least one of the first crank and the second crank.

25. Installation for generating a flow or whirl in a fluid, comprising an apparatus according to claim 22, wherein at least the foil is located in the fluid in which the flow or whirl is to be generated, wherein the apparatus comprises a drive for driving at least one of the heave crank mechanism and the pitch crank mechanism.

26. Installation, comprising at least two functionally connected apparatuses according to claim 22, wherein the apparatuses are out of phase with each other.
